(19) United States
(12) Patent Application Publication
(10) Pub. No.: US 2006/0259854 A1
(43) Pub. Date: Nov. 16, 2006

(54) Structuring an electronic document for efficient identification and use of document parts

(75) Inventors: Charles Scott Walker, Sammarnish, WA (US); Brian Jones, Redmond, WA (US); Chad Rothschiller, Edmonds, WA (US); Shawn Villaron, San Jose, CA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/125,907

(22) Filed: May 10, 2005

(51) Int. Cl. G06F 17/00

(52) U.S. Cl. 715/501.1

(57) ABSTRACT

Methods and computer-readable mediums structure an electronic document for identification and use of document parts. A method involves organizing parts of the electronic document as separate parts. The separate parts include resources internal and/or external to where the document is located. The method also involves representing a link between any of the parts as a relationship to be processed listed in a relationship part associated with a source part of the relationship. This relationship part contains a list of relationships for the source part and processing a relationship returns content of a target part of the relationship. Each relationship is also associated with a relationship type. Still further, the method involves representing via the relationship part how one or more parts relate to other separate parts, tracking internal resources, and tracking external resources. Thus, applications can infer the structure of the document by traversing the relationships.

### CROSS-REFERENCE TO RELATED APPLICATIONS

This patent application is related to U.S. patent application Ser. No. 10/836,326, entitled “Modular Document Format,” filed on Apr. 30, 2004; U.S. patent application, Attorney Docket No. 60001.0440US01, entitled “Management and Use of Data in a Computer-Generated Document,” filed on Dec. 20, 2004; U.S. patent application, Attorney Docket No. 60001.0441US01, entitled “File Formats, Methods, and Computer Program Products For Representing Documents,” filed on Dec. 20, 2004; U.S. patent application, Attorney Docket No. 60001.0443US01, entitled “File Formats, Methods, and Computer Program Products For Representing Presentations,” filed on Dec. 20, 2004; and U.S. patent application, Attorney Docket No. 60001.0447US01, entitled “File Formats, Methods, and Computer Program Products For Representing Workbooks,” filed on Dec. 20, 2004; all of which are assigned to the same assignee as this application. The aforementioned patent applications are expressly incorporated herein, in their entirety, by reference.

### FIELD OF THE INVENTION

The present invention generally relates to structuring electronic documents. More particularly, the present invention relates to improved structuring of an electronic document for efficient identification and use of its parts.

### BACKGROUND OF THE INVENTION

In some file formats today, links from document content to internal and external resources, such as embedded pictures, linked pictures, hyperlinks, and external data sources, are hidden within the opaque data of the document. There is little if any consistency between the persistent representations of the various types of links. Further, even for documents with a transparent file format, such as HTML or XML, it is non-trivial to discover the existence and purpose of links within the document's content. This makes it difficult to identify, audit, modify or repair links within files.

For example, anti-virus vendors have to rely on fragile techniques for identifying and removing code, such as Visual Basic for Applications (VBA) code, from within a document. Moreover, Enterprise administrators have no easy way of identifying or repairing documents having links that will be severed when a server is renamed. In order to identify, audit, modify, repair, and/or remove code within a document, deep technical knowledge of the file format and the persistence format of every type of link would be required. Even with this technical knowledge, a given document with a binary file format would still need to be fully read, parsed and understood in order to locate the links buried within the document. Even when there is capacity to identify, change, repair, and/or remove code for a special case, such as in when anti-virus software prunes VBA code from a document, mistakes or misunderstanding about the file format could lead to document corruption.

Accordingly there is an unaddressed need in the industry to address the aforementioned deficiencies and inadequacies.

### SUMMARY OF THE INVENTION

Embodiments of the present invention solve the above and other problems by providing methods, systems, and computer-readable mediums for structuring an electronic document for identification and/or use of document parts where the document parts have relationships with each other. In general, the present invention structures electronic documents to address concerns around hidden document content, such as document properties, code, and metadata, by enabling easy and open verification of document file content. Features of embodiments of the present invention include internal relationships dictating what document parts are loaded by applications accessing the document, external relationships tracking all external resource references, and/or policy or other mechanisms controlling what relationships are allowed.

One embodiment is a method for structuring an electronic document for identification or use of document parts by a variety of applications. The method involves organizing parts of an electronic document as a collection of separate parts associated with an electronic document container. The separate parts may include a resource internal to the document and/or a resource external to where the document is located. The method also involves representing a link between any of the parts as a relationship listed in a relationship part associated with a part of the document that is a source part of one or more relationships. The relationship part contains a list of relationships for the source part where the relationships include the location of the part that is the target of the relationship, an indication as to whether the target part is internal or external, a specification of the type of the relationship, and an identifier that may be used to reference the specific relationship within the source part.

Still further, the method involves representing via the relationship part how one or more separate parts of the collection relate to other separate parts, tracking the resource internal to where the document is located via one of the internal relationships, and tracking the resource external to where the document is located via one of the external relationships. Thus, applications discovering a structure of the document can infer the structure of the document by processing or traversing the relationships without parsing or opening the document's application-specific content parts. Therefore, particular parts of the document that are of interest may be easily located, audited, modified, deleted, or copied apart from the rest of the document without having to open or edit the document's source or target parts.

Another embodiment is a computer-readable medium having control logic stored therein for causing a computer to structure an electronic document. The control logic includes computer-readable program code for causing the computer to organize parts of a document as a collection of separate parts wherein the parts include a resource internal to and/or a resource external to where the document is located. The control logic also includes computer-readable program code for causing the computer to represent a link between any of the parts as a relationship listed in a relationship part associated with a part of the document that is a source part of one or more relationships to be processed. The relationship part contains a list of relationships for the source part and processing the relationships returns content of target parts of the relationships. The relationships may include the location of the part that is the target of the relationship, an indication as to whether the part is internal or external, a specification of the type of the relationship, and/or an identifier that may be used to reference the specific relationship within the source part. The control logic also includes computer-readable program code for causing the computer to represent via the relationship part how one or more separate parts of the collection relate to other separate parts. Thus, application can infer a structure of the document by traversing the relationships without parsing the document's application-specific content parts.

Still another embodiment is a computer-readable medium having computer-executable components. The computer-executable components include a first component that is arranged to identify from a source part of an electronic document a target part of the document in a relationship with the source part. The relationship defines a link between the source part and the target part and the first component is an identifier that is unique within a relationship part containing a list of relationships associated with the source part. This identifier is randomly generated when the relationship is created. The computer-executable components also include a second component including a uniform resource identifier (URI) arranged to define a role of the relationship, a third component including a second URI arranged to point to the target part, and a fourth component arranged to specify whether the third component points to a resource inside the electronic document or a resource outside the electronic document.

These and other features and advantages, which characterize the present invention, will be apparent from a reading of the following detailed description and a review of the associated drawings. It is to be understood that both the foregoing general description and the following detailed description are exemplary and explanatory only and are not restrictive of the invention as claimed.

### BRIEF DESCRIPTION OF THE DRAWINGS

FIG. 1 is a block diagram showing the architecture of a personal computer that provides an illustrative operating environment for embodiments of the present invention;

FIGS. 2a-2b are block diagrams illustrating an electronic document relationship hierarchy for various document parts utilized in representing an electronic presentation document according to an illustrative embodiment of the present invention;

FIG. 3 is a diagram that illustrates schema associated with relationships representing links between parts of an electronic document according to illustrative embodiments of the present invention; and

FIG. 4 is an illustrative operational flow performed in structuring electronic documents for efficient identification and use of document parts according to an illustrative embodiment of the present invention.

### DETAILED DESCRIPTION

As briefly described above, embodiments of the present invention are directed to methods, computer-readable media, and systems for structuring an electronic document for identification or use of document parts. These embodiments may be combined, other embodiments may be utilized, and structural changes may be made without departing from the spirit or scope of the present invention. The following detailed description is therefore not to be taken in a limiting sense and the scope of the present invention is defined by the appended claims and their equivalents.

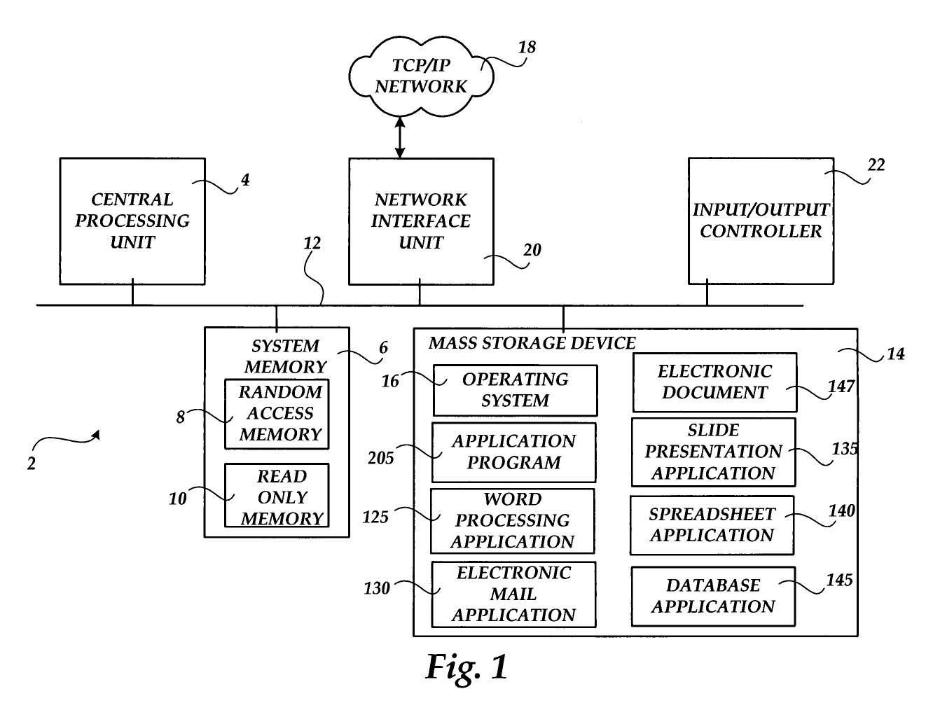

Referring now to the drawings, in which like numerals refer to like elements through the several figures, aspects of the present invention and an exemplary operating environment will be described. FIG. 1 and the following discussion are intended to provide a brief, general description of a suitable computing environment in which the invention may be implemented. While the invention will be described in the general context of program modules that execute in conjunction with an application program that runs on an operating system on a personal computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

Turning now to FIG. 1, an illustrative architecture for a personal computer 2 for practicing the various embodiments of the invention will be described. The computer architecture shown in FIG. 1 illustrates a conventional personal computer, including a central processing unit 4 (“CPU”), a system memory 6, including a random access memory 8 (“RAM”) and a read-only memory (“ROM”) 10, and a system bus 12 that couples the memory to the CPU 4. A basic input/output system containing the basic routines that help to transfer information between elements within the computer, such as during startup, is stored in the ROM 10. The personal computer 2 further includes a mass storage device 14 for storing an operating system 16, application programs, such as the application program 105, and data.

The mass storage device 14 is connected to the CPU 4 through a mass storage controller (not shown) connected to the bus 12. The mass storage device 14 and its associated computer-readable media, provide non-volatile storage for the personal computer 2. Although the description of computer-readable media contained herein refers to a mass storage device, such as a hard disk or CD-ROM drive, it should be appreciated by those skilled in the art that computer-readable media can be any available media that can be accessed by the personal computer 2.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the personal computer 2 may operate in a networked environment using logical connections to remote computers through a TCP/IP network 18, such as the Internet. The personal computer 2 may connect to the TCP/IP network 18 through a network interface unit 20 connected to the bus 12. It should be appreciated that the network interface unit 20 may also be utilized to connect to other types of networks and remote computer systems. The personal computer 2 may also include an input/output controller 22 for receiving and processing input from a number of devices, including a keyboard or mouse (not shown). Similarly, an input/output controller 22 may provide output to a display screen, a printer, or other type of output device.

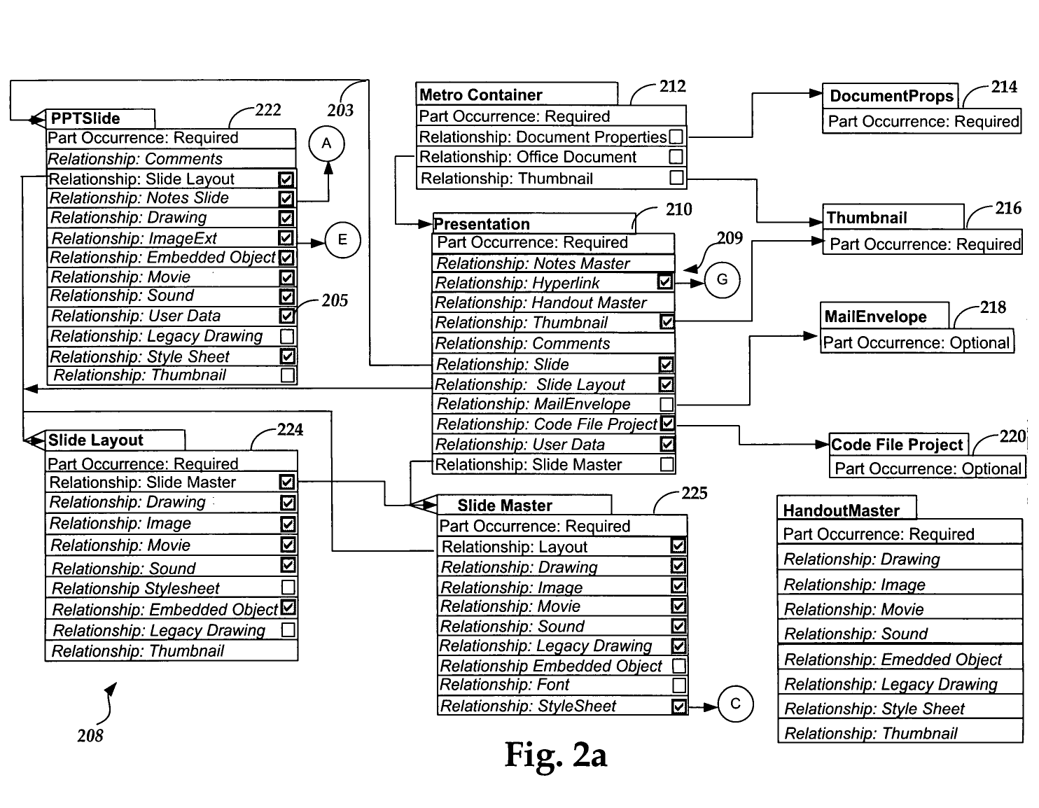

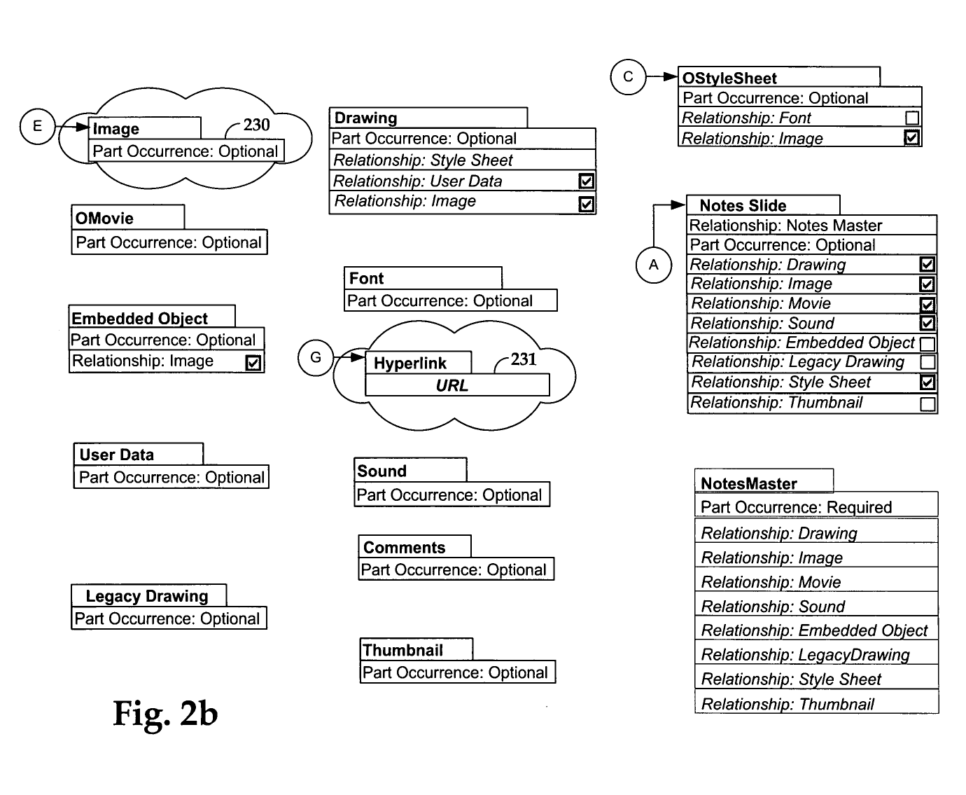

As mentioned briefly above, a number of program modules and data files may be stored in the mass storage device 14 and RAM 8 of the personal computer 2, including an operating system 16 suitable for controlling the operation of a networked personal computer, such as the WINDOWS operating systems from Microsoft Corporation of Redmond, Wash. The mass storage device 14 and RAM 8 may also store one or more application programs. In particular, the mass storage device 14 and RAM 8 may store an application program 105 for providing a variety of functionalities to a user. For instance, the application program 105 may comprise many types of programs such as a word processing application, a spreadsheet application, a desktop publishing application, and the like. According to an embodiment of the present invention, the application program 105 comprises a multiple functionality software application suite for providing functionality from a number of different software applications. Some of the individual program modules that may comprise the application suite 105 include a word processing application 125, a slide presentation application 135, a spreadsheet application 140 and a database application 145. An example of such a multiple functionality application suite 105 is OFFICE manufactured by Microsoft Corporation. One or more of the program modules are capable of producing electronic documents such as an electronic document 147. Other software applications illustrated in FIG. 1 include an electronic mail application 130. Additional details regarding structuring an electronic document, such as the electronic document 147, will be described below with respect to FIGS. 2a-5.

Referring now to FIGS. 2a-2b, block diagrams illustrating an electronic document relationship hierarchy, for example a presentation relationship hierarchy 208, for various document parts utilized in the electronic document 147 for representing a presentation and/or a presentation template according to various illustrative embodiments of the invention will be described. The electronic document 147 is structured for efficient identification and/or use of its document parts, such as by a variety of applications. As represented by the relationship hierarchy 208, various parts of the electronic document 147 are organized as a collection of separate parts associated with an electronic document container 212. A presentation part 210 is a core starting source part of the electronic document 147 from which other document parts are targets. The separate parts include resources internal to where the presentation part 210 is located and/or resources external to where the presentation part 210 is located.

The various document parts or components of the presentation relationship hierarchy 208 are logically separate but are associated by one or more relationships. Each part is also associated with a relationship type and is capable of being interrogated or discovered separately without other parts being discovered. Discovering a structure of the document 147 may include loading each relationship type associated with a relationship within the container, navigating through relationship parts, traversing lists of the relationships, and locating document parts to be audited, modified, deleted, and/or copied without parsing source or target parts of the document.

According to one embodiment of the present invention, the electronic document container 212 may be in the form of a zip file. Accordingly, rather than having all of the parts of the document stored as a single monolithic entity, the document is divided into the separate components making up the document where each of the components have explicit or implicit relationships to each other. Example relationships include relationships that point to resources stored outside a document (for example, a word processing document with a relationship to a picture stored on a web server). Other relationships include relationships that carry additional data (other than just source, target and type). An example of such “additional data” includes a unique identifier that allows unambiguous reference to a specific relationship. Other example relationships carry data about a “subcomponent” or “subset” of a target component they point to, for example, a relationship that points to “cell B3 of spreadsheet ABC” instead of just “spreadsheet ABC.”

Links between any of the document parts are represented as relationships listed in a relationship part, such as a relationship part 209, associated with a part of the document that is a source part, such as the presentation part 210, of one or more relationships. The relationship part 209 contains a list of relationships for the source part 210 where the relationships include internal relationships between an internal resource and another internal resource and/or external relationships between an internal resource and an external resource. Each relationship is also associated with a relationship type, for example an absolute uniform resource identifier (URI) that uniquely defines the role of the associated relationship.

A document part “type” associated with components of a given document allow for efficiently finding certain parts of the document when navigating the relationships between the components of the document. The relationship “type,” as described above, does not identify the type of content of a particular component, but instead the relationship type identifies how a parent component of a given component uses the component. That is, it is the content type of the part that actually identifies the part. For example, for an image component of a document, the relationship type may be “http://schemas.microsoft.com/office/2005/relationships/image,” but the content type associated with the component may be “image/jpeg” or “image/gif.”

Relationships may be represented using XML within relationship parts. Each part in the container 210 that is the source of one or more relationships has an associated relationship part. This relationship part holds the list of relationships for that source part. A source part and its associated relationship part may be connected by a naming convention. For instance, the relationship part for a source part in a given “folder” in a name hierarchy may be stored in a “sub-folder” called “_rels”. Thus, the name of this relationship-holding part may be formed by appending a “.rels” extension to the name of the original source part. For example, the relationship part for /xl/workbook.xmlis/xl/_rels/workbook.xml.rels.

Each relationship part represents how one or more separate parts relate to other separate parts. The internal resources are tracked via the internal relationships and the external resources are tracked via the external relationships. Thus, applications attempting to discover the structure of the electronic document 147 can infer the structure by traversing the relationships without parsing the document's application-specific content parts otherwise known as the source parts and target parts of the document.

The modular structure also offers a number of other benefits. For example, internal relationships dictate which of the document parts are loaded by an application when the application is loading the electronic document 147. Another benefit of structuring an electronic document in this manner is control over which of the relationships are valid based on a policy of confirming whether a target part referenced by a source part via a relationship listed in a relationship part matches the relationship listed. For instance, when the target part identified as mail envelope part 218 is associated with a relationship other than a mail envelope relationship, that relationship will be controlled as invalid because the target part does not match or correspond to the relationship. Thus, the document's structural integrity can be enforced.

It should be appreciated that controlling which relationships are recognized as valid may involve severing one of the relationships recognized as invalid. Severing one of the relationships effectively removes the target part from the collection. Further, because relationships are managed separately from the actual application-specific content, this severing of parts can be done without parsing, understanding, or modifying that content. For example, if a presentation slide part 222 includes a linked image 230, one could remove that image by removing the relationship that targets image 230. Note that the content of slide part 222 may still include the identifier referencing the relationship that targeted image 230, but the application can treat the image as though it had been removed. Until a target part is severed, the lifetime of a target part is bound to the source part. The source part owns the lifetime of the target part. For example, the presentation start part 210 owns the lifetime of each slide part 222.

The presentation relationship hierarchy 208 lists specific presentation application relationships some with an explicit reference indicator 205 indicating an explicit reference to that relationship in the content of the source part, for example via a relationship identifier. Relationships without an explicit reference indicator 205, may potentially utilize features from a target document part without an explicit reference. Document content that explicitly references parts does so via a relationship identifier (ID), rather than a part name or physical path. A relationship ID is unique within a relationship part. This allows a source part to refer to a target through indirection, rather than needing to have a reference directly to the target URI within the content. This facilitates discovery of all links within a document, for example, without needing to understand or parse the content markup. Document parts referenced implicitly are referenced without the use of a relationship ID.

Document parts that represent global or otherwise “unanchored” data structures are related to a “main” content part of a document. Global data structures are capable of being referenced by any part of the document. For example, the code file project 220, a global data structure containing macrocode for the document, is related to the “main” presentation part 210 of the document 147. Generally, other parts that use information from a global part do so directly in their own application-specific way, rather than having an individual relationship to the global part or using relationship IDs in their content. However, in some cases it makes sense to establish explicit relationships for a scenario-specific reason.

For instance, parts within a container are related to other non-global parts when it is valuable to be able to track the relationship explicitly even when use of a relationship ID to find the target is not necessary. For example, when a target part's lifetime is bound to the source part's lifetime, such as when an image part 230 is referenced by the slide part 222. Another scenario is when a target needs to travel with a source part, such as when a slide master part 225 needs to move with a slide layout part 224. Still, another scenario is when a target part needs to be easily found without parsing source part content, for example a code file project part 220 and the image part 230 whether internal or external may need to be easily found without parsing the content of their respective source part.

Another scenario where explicit relationships are useful is referencing a target part by relationship ID, rather than being tied directly to the target part's name. This may be particularly true when the source part needs to refer to a target part that is one of many of a given type. For example, a slide part is referenced by the presentation part 210 with an explicit relationship ID. Still, another scenario where an explicit relationship reference is useful is when the target part is an external resource. Explicit references for external resources are important for manageability, consistency, and security of links, such as a link between the slide part 222 and an external image file 230 or a link between the presentation slide part 222 and a hyperlink part 231.

A document structure framework may include the electronic document container 212 associated with the document parts. The document parts include, the presentation part 210 representing a start part for a presentation, a document properties part 214 containing built-in properties associated with the document 147, and a thumbnail part 216 containing thumbnails associated with the document 147. Parts directly referenced by the electronic document container are also associated with package relationships. Package relationships are used to locate well-known parts by using a well-known and unique relationship within the package, rather than by relying on well-known paths and part names within the package. This is to avoid collisions and allow for multiple documents' parts within a single package. The application program 105 uses a well-known package relationship type, such as http://schemas.microsoft.com/office/2005/relationships/officeDocument, to locate the document's core part, such as the presentation part 210. The loading application will verify that the content type of this part is correct, and fail loading if not.

In addition, the application program 105 will read and write package relationships to locate the document Thumbnail and Document Properties parts. These relationships can also be duplicated off of the core part, to keep the document self-contained. Additional common parts, such as image parts, Style sheet parts, or Fonts, are located through relationships off of the core part, not package relationships. This prevents potential collisions in scenarios where a single package contains multiple documents.

In various embodiments of the invention, the relationship parts may be formatted according to extensible markup language (“XML”). As is understood by those skilled in the art, XML is a standard format for communicating data. In the XML data format, a schema is used to provide XML data with a set of grammatical and data type rules governing the types and structure of data that may be communicated. The XML data format is well-known to those skilled in the art, and therefore not discussed in further detail herein.

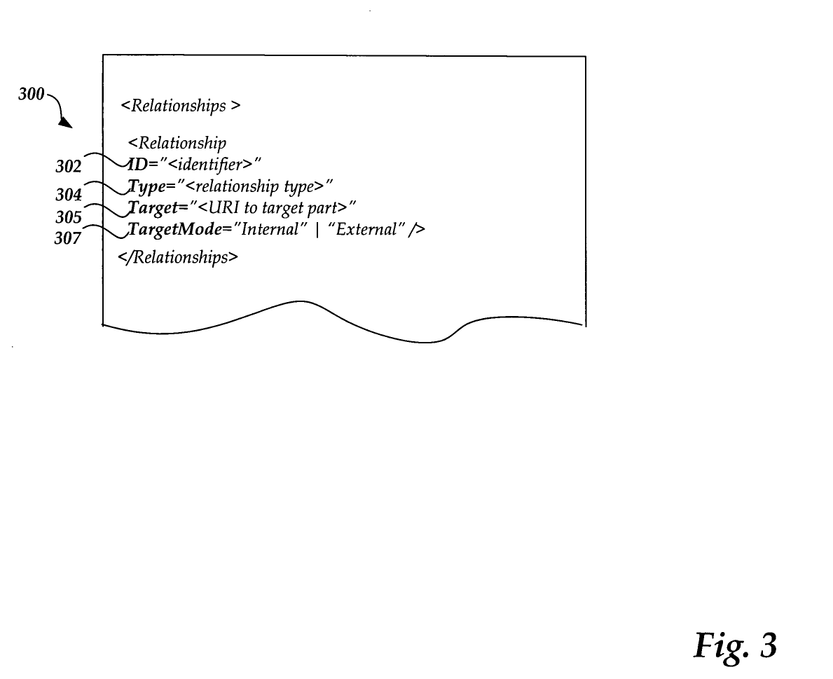

FIG. 3 is a diagram that illustrates an illustrative schema 300 associated with relationships representing links between parts of an electronic document according to embodiments of the present invention. The parts or components of each relationship element include a relationship ID 302, a relationship type 304, a target 305, and a target mode 307. The relationship ID 302 is an identifier for the relationship within the relationship part and is used in source part content when referring to a target part rather than referencing the target part directly by a URI. Relationship IDs for relationships are unique within a given relationship part, but are not guaranteed to be unique beyond the relationship part. For the purposes of syntax, relationship IDs may follow the same rules as XML identifiers.

The relationship type 304 is an absolute URI that uniquely defines the role of the relationship. The target 305 is a URI that points to the part at the other end of the relationship. The target 305 may be relative or absolute. An absolute URI is a path that completely describes the location of the target, for example http://www.excel.com/mypicture.jpeg. Whereas, a relative path is one where location is dependent on the location of the document itself. If relative, the base URI is implied by the value of the TargetMode 307 attribute.

The TargetMode 307 specifies whether the target 305 is to a resource inside or outside the physical package or container 212. The default is “Internal”, in which case the attribute may be omitted, which means the target 305 URI is relative, and is to be resolved against the path to the source part. When the TargetMode 307 is “External”, the target 305 may be either an absolute path or a relative path resolved against the location of the document. If the target 305 is absolute, the TargetMode 307 must be “External”.

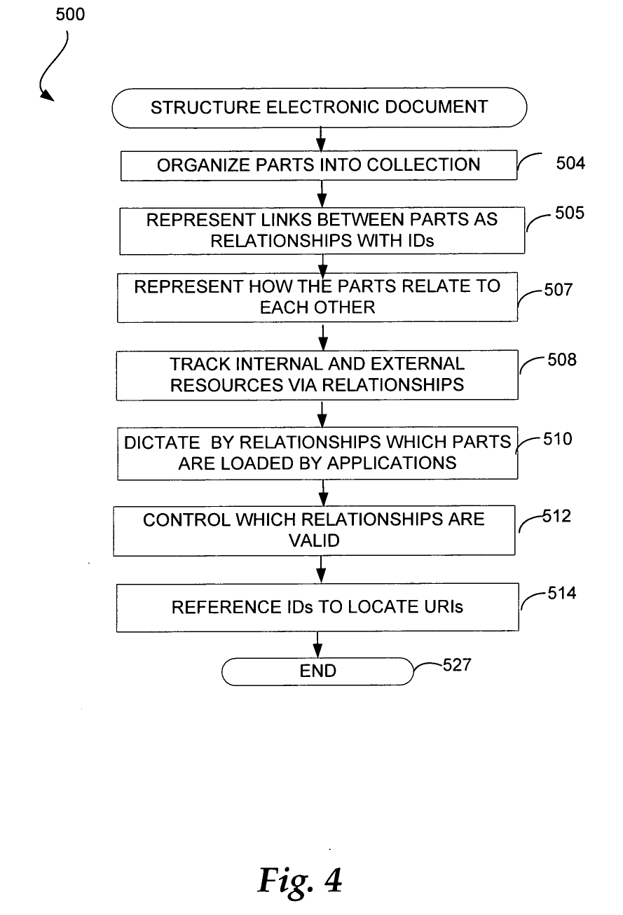

FIG. 4 is an illustrative operational flow 500 performed in structuring electronic documents for efficient identification and use of document parts according to an illustrative embodiment of the present invention. The operational flow 500 begins at operation 504 where the application 105 organizes the document into a collection of separate parts. According to embodiments of the present invention, organizing the document as a collection of individual parts, as illustrated in FIGS. 2a-2b, allows for the manipulation or processing of individual parts outside a particular application responsible for the main document 147. From operation 504, the operational flow 500 continues to operation 505.

At operation 505, the application 105 represents links between any of the parts as relationships referencing target parts from source parts. Then at operation 507, the application represents how the document parts relate to each other by associated relationship parts with document parts. The relationship parts list the relationships for a corresponding document or source part. The application 105 enforces all references from document content to target parts. The references are kept as formal relationships whether the target parts are internal or external. Enforcing formal relationships prevents applications from ignoring relationship parts, which could theoretically be accomplished if the content referenced target URIs directly. Some of the source parts explicitly reference target parts using relationship IDs.

Using relationship IDs instead of absolute paths to reference parts facilitates a variety of benefits. For example, ID referencing allows linked parts to be modified without changing the original content that made the reference. For external resources, ID referencing allows changes to server names used in URLs by operating strictly on relationship files without parsing the document content parts. Processing relationships returns content of target parts of the relationships. Processing or traversing relationships may include returning a location of the part that is the target part of the relationship, returning an indication as to whether the target part is internal or external to the document, returning a relationship type associated with a relationship, and/or returning an identifier utilized to reference the relationship within the source part. From operation 507, the operational flow 500 continues to operation 508.

At operation 508, both internal and external resources are tracked by internal and external relationships respectively. This document structure offers the additional benefit that even if no changes are needed, it is beneficial for a user to be able to audit all of the external references in a document without having to parse all of the myriad content parts. For internal parts, resource tracking is also useful if a shared part needs to be renamed or replaced for some reason. Resource tracking allows all the links to the shared part to be modified by just touching a single point in a relationship “.rels” file (and/or working through all the “.rels” files), instead having to parse all the document content parts. From operation 508, the operational flow 500 continues to operation 510.

At operation 510, the internal relationships are structured to dictate which document parts are loaded by an application seeking to load the document. Internal relationships are relationships that help applications locate parts inside the document container that it needs to load in order to read a document. In addition, external relationships are used to help applications locate content that is stored outside of the document. These relationships represent a sum total of all parts that an application will consume. Internal relationships are used to ensure the integrity of the document. Only linked parts are loaded, and then only if the part is linked correctly.

For example, when the spreadsheet application 140 is loading a spreadsheet, it will load a code file project part only if the part is referenced by an appropriate relationship from a workbook part. Without this relationship, the project file will not be loaded. The project file will not be loaded when referenced by an incompatible relationship type, such as hyperlink or embedded object type. The relationship type must be compatible. This rule makes it easy to both detect, and eliminate code embedded in a document. This is also true of other parts. For example, embedded images will only be loaded when targeted by an appropriate relationship. An image relationship that targets a part that is not an image will be considered invalid and not loaded.

Next, at operation 512 a policy controls which relationships are deemed valid by applications. Because all parts loaded by an application are located by resolving relationships, relationships are used as a decision point for security-related or policy-driven hardening. For example, attempts to load an embedded image are always detectable because an image-related relationship will be found and followed. Policy may be in the form of processing rules in the program accessing the document. For example, policy may enforce that a part will never be loaded if the part isn't referenced by at least one relationship, as described above with regard to operation 510. Policy could also indicate which relationship types are deemed valid or invalid.

Policy can also be a transient setting, for example Group Policy deployed via Active Directory, in which case policy can temporarily prevent a program from accessing specific target parts by disallowing the relationship type of the relationship targeting them. Allowing a setting or policy to dictate what types of relationship are allowed or disallowed (globally, or for a given document) offers numerous benefits. For example, an administrator could now turn off all embedded JPEGs in all documents if security vulnerability were discovered in the way certain parts were handled. Thus, settings or policy may be set such that designated relationship types and/or target modes may be allowed or disallowed for loading even if a relationship is valid. For instance, all relationships with an external target mode or all image relationship types can be disallowed. From operation 512, the operational flow 500 continues to operation 514. At operation 514, relationship IDs are referenced to find URIs to the target parts. Document content that references another part, internal or external to the document, may do so by referencing the relationship ID, and finding the actual URI to the target part/resource through this indirection. There are no functional URIs embedded within content markup. Resources targeted by a relationship can be referenced in content using an attribute, such as “o:rel” for example, whose value is the relationship ID. This replaces any existing attributes whose value is a URL to a resource. With this design, a link can be locate by examining the relationships parts (*.rels), without having to understand or parse any of the application-specific content files. The operational flow 500 ends at operation 527. As a further illustration of structuring an electronic document for efficient identification and use its parts, examples are provided as follows:

### EXAMPLES

In previous formats of WordML, a hyperlink might appear like this in
the content:
...
<w:hlink
w:dest=“http://server/site/file.htm”><w:r><w:rPr><w:rStyle
w:val=“Hyperlink”/></w:rPr><w:t>This is a
hyperlink!</w:t></w:r></w:hlink>
...
In order to find this link, the WordML would have to parsed and the hlink
element found, then the dest attribute. In embodiments of the present
invention, the target of the link will be promoted to a relationship,
thus the markup in ./word/wordDoc.xml will reference the
relationship's ID as follows:
...
<w:hlink o:rel=“rId12” w:screenTip=“tooltip text here”>

<w:r>

<w:rPr>

<w:rStyle w:val=“Hyperlink”/>

</w:rPr>
<w:t>This is a hyperlink!</w:t>

</w:r>

</w:hlink>
...
The URI itself is located in the relationships part,
./word/_rels/wordDoc.xml.rels:
<Relationships>

```
...
<Relationship
  ID=“rld12”
  Target=“http://server/site/file.htm”
  Type=“http://schemas.microsoft.com/office/2004/8/relationships/
  hyperlink”
  TargetMode=“External”/>
```

...
</Relationships>
A similar example can be seen with linked pictures in WordML:
<w:pict>
<v:shape id=“_x0000_i1028” type=“#_x0000_t75”
style=“width:380.8pt;height:285.6pt”>
<v:imagedata src=“../My%20Documents/My%20Pictures/m620.jpg”/>
</v:shape>
</w:pict>
Which would become:
<w:pict>
<v:shape id=“_x0000_i1028” type=“#_x0000_t75”
style=“width:380.8pt;height:285.6pt”>
<v:imagedata o:rel=“rld9”/>
</v:shape>
</w:pict>

As described herein, embodiments of the present invention provide for the structuring of an electronic document for identification and/or use of document parts. Each of the document parts are stored, maintained or reference by an electronic document container in which is maintained a hierarchical relationship representation showing the explicit or implicit relationships between each of the parts of the associated document. It will be apparent to those skilled in the art that various modifications or variations may be made in the present invention without departing from the scope or spirit of the invention. Other embodiments of the invention will be apparent to those skilled in the art from consideration of the specification and practice of the invention disclosed herein.

We claim:

1. A method for structuring an electronic document for identification or use of document parts by a variety of applications, the method comprising:
organizing parts of an electronic document as a collection of separate parts associated with an electronic document container wherein the parts comprise at least one of a resource internal to the document or a resource external to where the document is located;
representing a link between any of the parts as a relationship listed in a relationship part associated with a part of the document that is a source part of one or more relationships to be processed wherein the relationship part contains a list of relationships for the source part and wherein processing the relationships returns content of a part that is a target part of a relationship;
representing via the relationships part how one or more separate parts of the collection relate to other separate parts;
tracking the resource internal to the document via an internal relationship; and
tracking the resource external to where the document is located via an external relationship;
whereby applications discovering a structure of the document can infer the structure by traversing the relationships without parsing any source part or target part of the document.

2. The method of claim 1, wherein processing the relationships comprises returning a location of the part that is the target part of the relationship.

3. The method of claim 2, wherein processing the relationships further comprises returning an indication as to whether the target part is internal or external to the document.

4. The method of claim 2, wherein processing the relationships further comprises returning a relationship type associated with a relationship.

5. The method of claim 2, wherein processing the relationships further comprises returning an identifier utilized to reference the relationship within the source part.

6. The method of claim 1, further comprising dictating by internal relationships which of the separate parts are loaded by the applications when the document is loaded.

7. The method of claim 1, further comprising controlling which of the relationships are valid based on confirming whether a target part referenced by the source part via a relationship listed in the relationship part matches the relationship listed.

8. The method of claim 7, wherein controlling which of the relationships are valid comprises severing one of the relationships that does not match the target part wherein severing one of the relationships effectively removes the target part from the collection.

9. The method of claim 7, further comprising binding a lifetime of the target part to the source part.

10. The method of claim 1, further comprising dictating by at least one of relationship type or target mode which of the separate parts is loaded when applications load the document.

11. The method of claim 1, further comprising relating at least one of the parts to a main content part of the collection wherein the at least one part represents a data structure capable of being referenced by any part of the document.

12. The method of claim 1, wherein representing a link between any of the parts as a relationship listed in a relationship part comprises expressing the list of relationships in extensible markup language (XML).

13. The method of claim 3, wherein each relationship type comprises an absolute uniform resource identifier that uniquely defines a role of a relationship and wherein discovering a structure of the document comprises:
loading each relationship type associated with a relationship;
navigating through at least one of the relationship parts;
traversing at least one list of relationships; and
locating one of the separate parts to be at least one of audited, modified, deleted, or copied without parsing any source part or any target part of the document.

14. A computer-readable medium having control logic stored therein for causing a computer to structure an electronic document, the control logic comprising computer-readable program code for causing the computer to:
organize parts of a document as a collection of separate parts wherein the parts comprise at least one of a resource internal to the document or a resource external to where the document is located;
represent a link between any of the parts as a relationship listed in a relationship part associated with a part of the document that is a source part of one or more relationships to be processed wherein the relationship part contains a list of relationships for the source part and wherein processing the relationships returns content of a part that is a target part of a relationship; and
represent via the relationship part how one or more separate parts of the collection relate to other separate parts;
whereby an application can infer a structure of the document by traversing the relationships without parsing any source part or any target part of the document.

15. The computer-readable medium of claim 14, further comprising computer-readable program code for causing the computer when representing via the relationship part how one or more separate parts of the collection relate to other separate parts to:
track the resource internal to the document via an internal relationship; and
track the resource external to where the document is located via an external relationship.

16. The computer-readable medium of claim 14, further comprising computer-readable program code for causing the computer to dictate by internal relationships which of the parts are loaded by the application when the document is loaded.

17. The computer-readable medium of claim 14, wherein a relationship type comprising an absolute uniform resource identifier that uniquely defines a role of a relationship is associated with each relationship.

18. A computer-readable medium having computer-executable components, comprising:
a first component that is arranged to identify from a source part of an electronic document a target part of the document in a relationship with the source part wherein the relationship defines a link between the source part and the target part and wherein the first component is unique within a relationship part containing a list of relationships associated with the source part;
a second component comprising a uniform resource identifier (URI) arranged to define a role of the relationship;
a third component comprising a second URI arranged to point to the target part; and
a fourth component arranged to specify whether the third component points to one of a resource inside the electronic document or a resource outside the electronic document.

19. The computer-readable medium of claim 18, wherein the third component comprises one of an absolute URI or a relative URI when the third component comprises the absolute URI, the fourth component points to the resource outside the electronic document; and
wherein when the third component comprises the relative URI, the second URI is implied by a value of the fourth component.

20. The computer-readable medium of claim 19, wherein when the fourth component specifies that the third component points to the resource inside the electronic document, the third component comprises the relative URI resolved against a path to the source part; and
wherein when the fourth component specifies that the third component points to the resource outside the electronic document, the third component comprises one of the absolute URI or the relative URI resolved against a location of the electronic document.
